(19) United States
(12) Patent Application Publication
(10) Pub. No.: US 2014/0033175 A1
(43) Pub. Date: Jan. 30, 2014

(54) COMPUTING DEVICE AND METHOD FOR CREATING TEST CASES OF SOFTWARE PROGRAM

(71) Applicants: Hon Hai Precision Industry Co., Ltd., New Taipei (TW); Hong Fu Jin Precision Industry (ShenZhen) Co. Ltd., Shenzhen (CN)

(72) Inventors: CHUNG-I LEE, New Taipei (TW); HAO ZHOU, Shenzhen (CN)

(21) Appl. No.: 13/920,051

(22) Filed: Jun. 17, 2013

(30) Foreign Application Priority Data
Jul. 27, 2012 (CN) 2012102639400

(51) Int. Cl. G06F 11/36

(52) U.S. Cl. CPC G06F 11/3684
USPC 717/124

(57) ABSTRACT

In a method for creating test cases of a software program using a computing device, syntax keywords of a test script and a test template are defined. One or more test scripts are created according to a test requirement file stored in a storage device of the computing device, and each of the test scripts is parsed according to the syntax keywords. The method generates a matrix for each of the test cases according to the test scripts when the test script is parsed successfully, integrates all of the matrixes to generate an integrated matrix, and deleting all test items repeated in the integrated matrix. The method further creates a test case for each test item remaining in the integrated matrix using the test template, and stores all the test cases in the storage device.

### BACKGROUND

1. Technical Field

Embodiments of the present disclosure relate to software compiling systems and methods, and particularly to a computing device and a method for creating test cases of a software program.

2. Description of Related Art

Test cases are useful to test functions of software systems according to user requirements. Each of the test cases is a software program that is embedded in a software system. When the test cases are executed in the software system, execution results of the software system are generated. When a software program system is developed by software engineers, many test cases need to be programmed for testing various performance of the software system, such as testing stability, reliability, validity or security of the software system. Therefore, the software engineers need to design different test cases manually according to the user requirements. However, designing test cases is costly and inefficient if done manually. Therefore, there is need a system and method for automatically creating test cases of the software programs to increase efficiency.

### BRIEF DESCRIPTION OF THE DRAWINGS

FIG. 1 is a block diagram of one embodiment of a computing device including a test case creating system.

FIG. 2 is a method for creating test cases of software programs installed in the computing device of FIG. 1.

FIG. 3 is one exemplary embodiment of an integrated matrix by integrating all matrixes of the test cases.

FIG. 4 is one exemplary embodiment of a test case of the software program.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

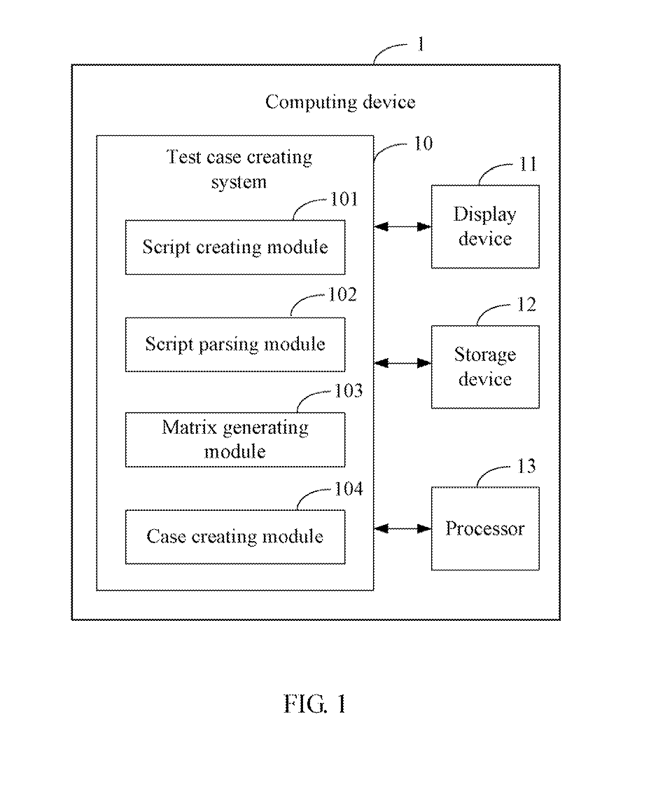

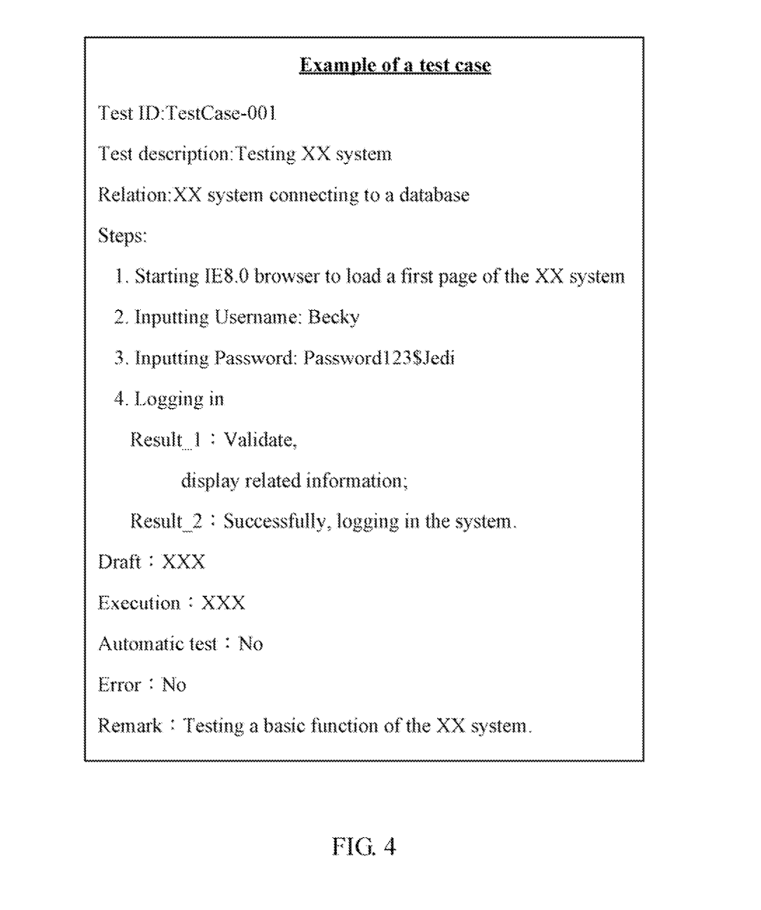

FIG. 1 is a block diagram of one embodiment of a computing device 1 including a test case creating system 10. In the embodiment, the test case creating system 10 creates one or more test scripts according to user requirements, and uses the test scripts to generate a plurality of test cases of a software program. Each of the test cases is used to test performance of the software program, such as stability, reliability, validity and security of the software program. FIG. 4 shows one exemplary embodiment of a test case for testing the software program. Each of the test cases includes basic information and extension information of the software program. The basic information may include an test ID, a test description, test data, test steps and a test result of the software program. The extension information may include a draft, an executor, or remarks of the software program, and can be added into the test case according to the user requirements.

The computing device 1 includes, but is not limited to, a display device 11, a storage device 12 and at least one processor 13. The computer device 1 is a computer, a server or other electronic device. In one embodiment, the test case creating system 10 may include computerized instructions in the form of one or more programs that are stored in the storage device 12 and executed by the at least one processor 13. FIG. 1 illustrates only one example of the computing device 1, other examples may include more or fewer components than illustrated, or have a different configuration of the various components in other embodiments.

In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, or a data storage medium. The at least one processor 13 is a central processing unit (CPU) or a microprocessor that performs various functions of the computing device 1.

In the embodiment, the test case creating system 10 includes a script creating module 101, a script parsing module 102, a matrix generating module 103, and a case creating module 104. The modules 101-104 may comprise computerized instructions in the form of one or more programs that are stored in the storage device 12 and executed by the at least one processor 13. A description of each module is given in the following paragraphs.

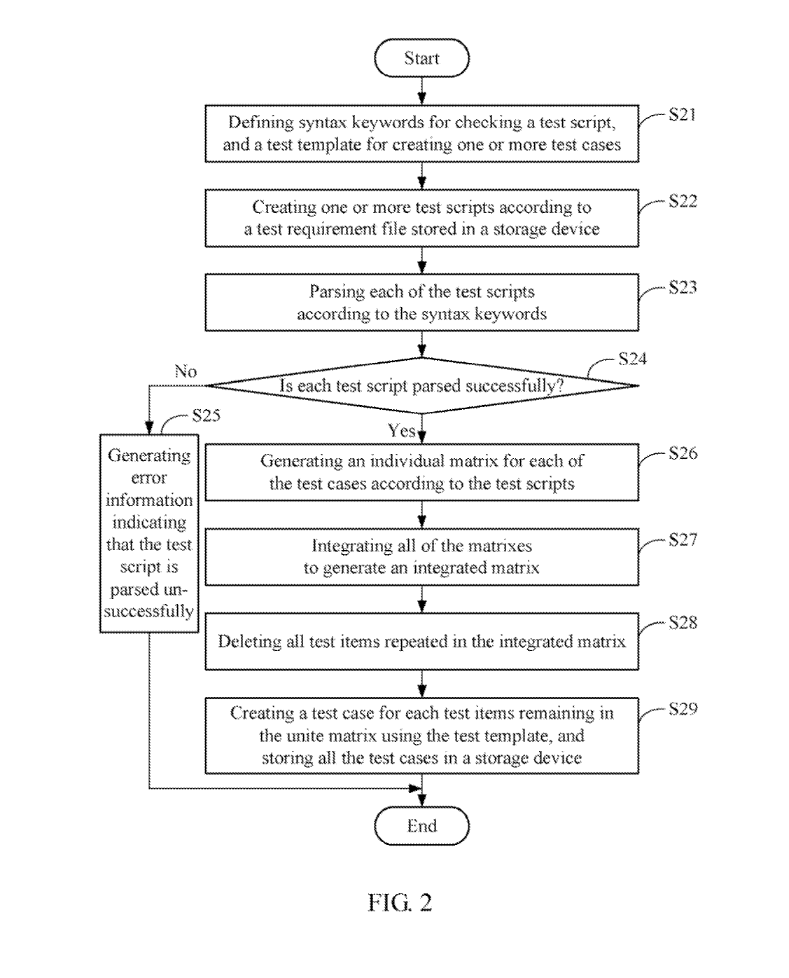

FIG. 2 is a flowchart of one embodiment of a method for creating test cases of software programs installed in the computing device 1 of FIG. 1. The method is performed by execution of a computer-readable program code or instructions by the at least one processor 13 of the computing device 1. Depending on the embodiment, additional steps may be added, others removed, and the ordering of the steps may be changed.

In step S21, the script creating module 101 defines a plurality of syntax keywords of a test script, and a test template for creating one or more test cases. In the embodiment, the test script is a syntax parsing packet that is programmed by a specific programming language, such as a Python language or a pre-parsing language. The test template of the test case is an extendable user-defined template which contains the basic information and the extension information of the software program.

In step S22, the script creating module 101 creates one or more test scripts according to a test requirement file stored in the storage device 12. In one embodiment, the test requirement file includes a test number, a test item, and a predicted result of the test case.

In step S23, the script parsing module 102 parses each of the test scripts according to the syntax keywords. In the embodiment, the syntax keywords is predefined according to the user requirements, and may include a script definition, a logic determination, a cycle test, a test process, a test rule, a test point and a test environment of the software program. For example, the script definition can be defined as a keyword “var. define”, the logic determination can be defined as keywords if . . . else . . . , the cycle test can be defined as keywords do . . . while . . . , for . . . , and for each . . . , the test process can be defined as keywords steps . . . , the test rule is defined as rule or rules, the test point is defined as checkpoint, check, or checks, and the test environment is defined as operating platform and etc.

In step S24, the script parsing module 102 determines whether each of the test scripts is parsed successfully. If any test script is parsed unsuccessfully, block S25 is implemented. Otherwise, if each of the test scripts is parsed successfully, block S26 implemented.

In step S25, the script parsing module 102 generates error information indicating that the test script is parsed unsuccessfully, and displays the error information on the display device 11.

In step S26, the matrix generating module 103 generates a matrix for each of the test cases according to the test scripts. The matrix of each of the test cases contains an test number, a test item and a test result of each of the test cases.

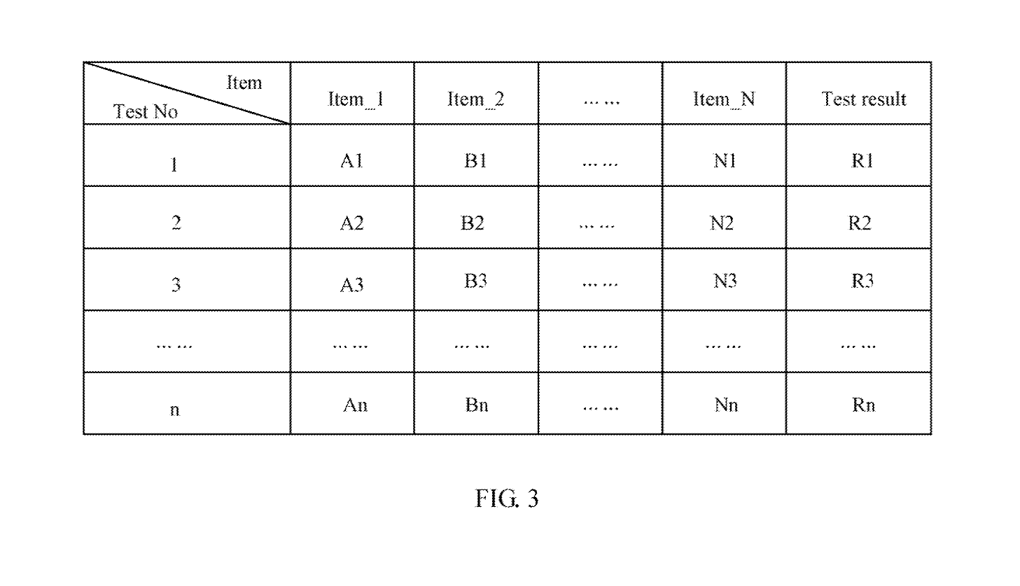

In step S27, the matrix generating module 103 integrates all of the matrixes to generate an integrated matrix for the test cases. FIG. 3 is one exemplary embodiment of the integrated matrix by integrates all of the matrixes. The integrated matrix includes a column for recording all numbers of the test cases, a column for recording items of the test cases, and a column for recording test results of the test cases.

In step S28, the matrix generating module 103 deletes test items repeated in the integrated matrix. In the embodiment, the matrix generating module 103 checks whether the integrated matrix has repeated test items, and deletes all the repeated test items from the integrated matrix if the integrated matrix has the repeated test items.

In step S29, the case creating module 104 creates a test case for each test items remaining in the integrated matrix using the test template, and stores all the test cases in the storage device 12. As such, the software program can obtain one or more test cases from the storage device 12 when the software program is tested, and executes the test cases to test a corresponding function of the software program.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage device storing one or more computer-readable program instructions, which when executed by the at least one processor, causes the at least one processor to:
define a plurality of syntax keywords of a test script, and define a test template for creating one or more test cases of a software program;
create one or more test scripts according to a test requirement file stored in the storage device;
parse each of the test scripts according to the syntax keywords;
determine whether each of the test scripts is parsed successfully;
generate a matrix for each of the test cases according to the test scripts if each of the test scripts is parsed successfully;
integrate all of the matrixes to generate an integrated matrix for the test cases, and delete all test items repeated in the integrated matrix; and
create a test case for each test item remaining in the integrated matrix using the test template, and store all the test cases in the storage device.

2. The computing device according to claim 1, wherein the computer-readable program instructions further cause the at least one processor to generate error information indicating that the test script is parsed unsuccessfully if any test script is parsed unsuccessfully, and displays the error information on a display device of the computing device.

3. The computing device according to claim 1, wherein each of the test cases is used to test performance of the software program including stability, reliability, validity and security of the software program.

4. The computing device according to claim 1, wherein each of the test cases includes basic information and extension information of the software program.

5. The computing device according to claim 4, wherein the basic information comprises an test ID, a test description, test data, test steps and a test result of the software program, and the extension information comprises a draft, an executor, and remarks of the software program that is added into the test case according to user requirements.

6. The computing device according to claim 1, wherein the syntax keywords comprise a script definition, a logic determination, a cycle test, a test process, a test rule, a test point and a test environment of the software program.

7. A method for creating test cases of a software program using a computing device, the method comprising:
defining a plurality of syntax keywords of a test script, and defining a test template for creating one or more test cases;
creating one or more test scripts according to a test requirement file stored in a storage device of the computing device;
parsing each of the test scripts according to the syntax keywords;
determining whether each of the test scripts is parsed successfully;
generating a matrix for each of the test cases according to the test scripts if each of the test scripts is parsed successfully;
integrating all of the matrixes to generate an integrated matrix for the test cases, and deleting all test items repeated in the integrated matrix; and
creating a test case for each test item remaining in the integrated matrix using the test template, and storing all the test cases in the storage device.

8. The method according to claim 7, further comprising:
generating error information indicating that the test script is parsed unsuccessfully if any test script is parsed unsuccessfully; and
displaying the error information on a display device of the computing device.

9. The method according to claim 7, wherein each of the test cases is used to test performance of the software program including stability, reliability, validity and security of the software program.

10. The method according to claim 7, wherein each of the test cases includes basic information and extension information of the software program.

11. The method according to claim 10, wherein the basic information comprises an test ID, a test description, test data, test steps and a test result of the software program, and the extension information comprises a draft, an executor, and remarks of the software program that are added into the test case according to user requirements.

12. The method according to claim 7, wherein the syntax keywords comprise a script definition, a logic determination, a cycle test, a test process, a test rule, a test point and a test environment of the software program.

13. A non-transitory storage medium having stored thereon instructions that, when executed by at least one processor of a computing device, cause the computing device to perform a method for creating test cases of a software program, the method comprising:
defining a plurality of syntax keywords of a test script, and defining a test template for creating one or more test cases;
creating one or more test scripts according to a test requirement file stored in a storage device of the computing device;
parsing each of the test scripts according to the syntax keywords;
determining whether each of the test scripts is parsed successfully;
generating a matrix for each of the test cases according to the test scripts if each of the test scripts is parsed successfully;
integrating all of the matrixes to generate an integrated matrix for the test cases, and deleting all test items repeated in the integrated matrix; and
creating a test case for each test item remaining in the integrated matrix using the test template, and storing all the test cases in the storage device.

14. The storage medium according to claim 13, wherein the method further comprises:
generating error information indicating that the test script is parsed unsuccessfully if any test script is parsed unsuccessfully; and
displaying the error information on a display device of the computing device.

15. The storage medium according to claim 13, wherein each of the test cases is used to test performance of the software program including stability, reliability, validity and security of the software program.

16. The storage medium according to claim 13, wherein each of the test cases includes basic information and extension information of the software program.

17. The storage medium according to claim 16, wherein the basic information comprises an test ID, a test description, test data, test steps and a test result of the software program, and the extension information comprises a draft, an executor, and remarks of the software program that are added into the test case according to user requirements.

18. The storage medium according to claim 13, wherein the syntax keywords comprise a script definition, a logic determination, a cycle test, a test process, a test rule, a test point and a test environment of the software program.
